(19) United States
(12) Patent Application Publication
(10) Pub. No.: US 2020/0319818 A1
(43) Pub. Date: Oct. 8, 2020

(54) SYSTEM AND METHOD FOR SUPPORTING LOW LATENCY IN A MOVABLE PLATFORM ENVIRONMENT

(71) Applicant: SZ DJI TECHNOLOGY CO., LTD., Shenzhen (CN)

(72) Inventors: Qingdong YU, Shenzhen (CN); Lei ZHU, Shenzhen (CN); Xiaodong WANG, Shenzhen (CN)

(21) Appl. No.: 16/909,495

(22) Filed: Jun. 23, 2020

Related U.S. Application Data
(63) Continuation of application No. PCT/CN2017/119498, filed on Dec. 28, 2017.

(51) Int. Cl. G06F 3/06

(52) U.S. Cl. CPC G06F 3/0656; G06F 3/0659; G06F 3/067; G06F 3/0613; G06F 3/064

(57) ABSTRACT

A system for supporting data processing and communication in a movable platform environment includes a memory buffer with a plurality of buffer blocks each configured to store one or more data frames, and a plurality of data processors including at least a first data processor and a second data processor. The first data processor operates to perform a write operation to write data into one of the buffer blocks in the memory buffer and provide a reference to the second data processor via a connection between the first data processor and the second data processor. The reference indicates a status or progress of the write operation performed by the first data processor. The second data processor operates to perform a read operation to read the data from the one of the buffer blocks in the memory buffer based on the reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

This application is a continuation of International Application No. PCT/CN2017/119498, filed Dec. 28, 2017, the entire content of which is incorporated herein by reference.

### FIELD OF THE DISCLOSURE

The disclosed embodiments relate generally to operating a movable platform and more particularly, but not exclusively, to support data processing and communication in a movable platform environment.

### BACKGROUND

Movable platforms such as unmanned aerial vehicles (UAVs) can be used for performing surveillance, reconnaissance, and exploration tasks for military and civilian applications. Various applications can take advantage of such movable platform. For example, such applications may include remote video broadcast, remote machine vision, remote video interactive systems, and VR (virtual reality)/AR (augmented reality) human-computer interaction systems. It is widely accepted that the latency in video processing and transmission is critical to the user experience of such applications. This is the general area that embodiments of the disclosure are intended to address.

### SUMMARY

Described herein are systems and methods that can support data processing and communication in a movable platform environment. The system comprises a memory buffer with a plurality of buffer blocks, wherein each said buffer block is configured to store one or more data frames. The system also comprises a plurality of data processors comprising at least a first data processor and a second data processor. The first data processor operates to perform a first write operation to write data into a first buffer block in the memory buffer, and provide a first reference to the second data processor via a connection between the first data processor and the second data processor, wherein the first reference indicates a status or progress of the first write operation by the first data processor. Then, the second data processor operates to perform a read operation to read the data from the first buffer block in the memory buffer based on the received first reference.

### BRIEF DESCRIPTION OF DRAWINGS

FIG. 1 illustrates a movable platform environment, in accordance with various embodiments of the present disclosure.

FIG. 2 shows an exemplary video processing/transmission system, in accordance with various embodiments of the present disclosure.

FIG. 3 illustrates an exemplary video streaming system, in accordance with various embodiments of the present disclosure.

FIG. 4 illustrates an exemplary data processing system with low latency, in accordance with various embodiments of the present disclosure.

FIG. 5 shows supporting efficient data processing in a data processing system, in accordance with various embodiments of the present disclosure.

FIG. 6 shows an exemplary video processing system with low latency, in accordance with various embodiments of the present disclosure.

FIG. 7 illustrates an exemplary data processor in a data processing system with low latency, in accordance with various embodiments of the present disclosure.

FIG. 8 shows hardware and software collaboration in an exemplary data processing system, in accordance with various embodiments of the present disclosure.

FIG. 9 illustrates data processing based on a ring buffer in a data processing system, in accordance with various embodiments of the present disclosure.

FIG. 10 illustrates data processing with low latency based on a ring buffer in a data processing system, in accordance with various embodiments of the present disclosure.

FIG. 11 illustrates activating a hardware module in an exemplary data processing system, in accordance with various embodiments of the present disclosure.

FIG. 12 shows a flowchart of supporting data processing and communication in a movable platform environment, in accordance with various embodiments of the present disclosure.

### DETAILED DESCRIPTION

The disclosure is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The description of the disclosure as following uses an unmanned aerial vehicle (UAV) as example for a movable platform. It will be apparent to those skilled in the art that other types of movable platform can be used without limitation.

In accordance with various embodiments of the present disclosure, the system can provide a technical solution for supporting data processing and communication in a movable platform environment. The system comprises a memory buffer with a plurality of buffer blocks, wherein each said buffer block is adapted to store one or more data frames. The system also comprises a plurality of data processors comprising at least a first data processor and a second data processor. The first data processor operates to perform a first write operation to write data into a first buffer block in the memory buffer, and provide a first reference to the second data processor via a connection between the first data processor and the second data processor, wherein the first reference indicates a status or progress of the first write operation by the first data processor. Thus, the system can achieve minimum end-to-end delay and low overall latency for providing optimal user experience.

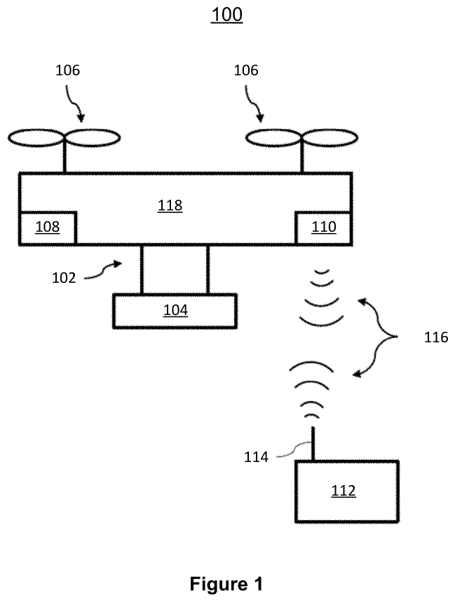

FIG. 1 illustrates a movable platform environment, in accordance with various embodiments of the present disclosure. As shown in FIG. 1, a movable platform 118 (also referred to as a movable object) in a movable platform environment 100 can include a carrier 102 and a payload 104. Although the movable platform 118 can be depicted as an aircraft, this depiction is not intended to be limiting, and any suitable type of movable platform can be used. One of skill in the art would appreciate that any of the embodiments described herein in the context of aircraft systems can be applied to any suitable movable platform (e.g., a UAV). In some instances, the payload 104 may be provided on the movable platform 118 without requiring the carrier 102.

In accordance with various embodiments of the present disclosure, the movable platform 118 may include one or more movement mechanisms 106 (e.g. propulsion mechanisms), a sensing system 108, and a communication system 110.

The movement mechanisms 106 can include one or more of rotors, propellers, blades, engines, motors, wheels, axles, magnets, nozzles, or any mechanism that can be used by animals, or human beings for effectuating movement. For example, the movable platform may have one or more propulsion mechanisms. The movement mechanisms 106 may all be of the same type. Alternatively, the movement mechanisms 106 can be different types of movement mechanisms. The movement mechanisms 106 can be mounted on the movable platform 118 (or vice-versa), using any suitable means such as a support element (e.g., a drive shaft). The movement mechanisms 106 can be mounted on any suitable portion of the movable platform 118, such on the top, bottom, front, back, sides, or suitable combinations thereof.

In some embodiments, the movement mechanisms 106 can enable the movable platform 118 to take off vertically from a surface or land vertically on a surface without requiring any horizontal movement of the movable platform 118 (e.g., without traveling down a runway). Optionally, the movement mechanisms 106 can be operable to permit the movable platform 118 to hover in the air at a specified position and/or orientation. One or more of the movement mechanisms 106 may be controlled independently of the other movement mechanisms.

Alternatively, the movement mechanisms 106 can be configured to be controlled simultaneously. For example, the movable platform 118 can have multiple horizontally oriented rotors that can provide lift and/or thrust to the movable platform. The multiple horizontally oriented rotors can be actuated to provide vertical takeoff, vertical landing, and hovering capabilities to the movable platform 118. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable platform 118 (e.g., with respect to up to three degrees of translation and up to three degrees of rotation).

The sensing system 108 can include one or more sensors that may sense the spatial disposition, velocity, and/or acceleration of the movable platform 118 (e.g., with respect to various degrees of translation and various degrees of rotation). The one or more sensors can include any of the sensors, including GPS sensors, motion sensors, inertial sensors, proximity sensors, or image sensors. The sensing data provided by the sensing system 108 can be used to control the spatial disposition, velocity, and/or orientation of the movable platform 118 (e.g., using a suitable processing unit and/or control module). Alternatively, the sensing system 108 can be used to provide data regarding the environment surrounding the movable platform, such as weather conditions, proximity to potential obstacles, location of geographical features, location of manmade structures, and the like.

The communication system 110 enables communication with terminal 112 having a communication system 114 via wireless signals 116. The communication systems 110, 114 may include any number of transmitters, receivers, and/or transceivers suitable for wireless communication. The communication may be one-way communication, such that data can be transmitted in only one direction. For example, one-way communication may involve only the movable platform 118 transmitting data to the terminal 112, or vice-versa. The data may be transmitted from one or more transmitters of the communication system 110 to one or more receivers of the communication system 112, or vice-versa. Alternatively, the communication may be two-way communication, such that data can be transmitted in both directions between the movable platform 118 and the terminal 112. The two-way communication can involve transmitting data from one or more transmitters of the communication system 110 to one or more receivers of the communication system 114, and vice-versa.

In some embodiments, the terminal 112 can provide control data to one or more of the movable platform 118, carrier 102, and payload 104 and receive information from one or more of the movable platform 118, carrier 102, and payload 104 (e.g., position and/or motion information of the movable platform, carrier or payload; data sensed by the payload such as image data captured by a payload camera; and data generated from image data captured by the payload camera). In some instances, control data from the terminal may include instructions for relative positions, movements, actuations, or controls of the movable platform, carrier, and/or payload. For example, the control data may result in a modification of the location and/or orientation of the movable platform (e.g., via control of the movement mechanisms 106), or a movement of the payload with respect to the movable platform (e.g., via control of the carrier 102). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view).

In some instances, the communications from the movable platform, carrier and/or payload may include information from one or more sensors (e.g., of the sensing system 108 or of the payload 104) and/or data generated based on the sensing information. The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable platform, carrier, and/or payload. Such information from a payload may include data captured by the payload or a sensed state of the payload. The control data transmitted by the terminal 112 can be configured to control a state of one or more of the movable platform 118, carrier 102, or payload 104. Alternatively or in combination, the carrier 102 and payload 104 can also each include a communication module configured to communicate with terminal 112, such that the terminal can communicate with and control each of the movable platform 118, carrier 102, and payload 104 independently.

In some embodiments, the movable platform 118 can be configured to communicate with another remote device in addition to the terminal 112, or instead of the terminal 112. The terminal 112 may also be configured to communicate with another remote device as well as the movable platform 118. For example, the movable platform 118 and/or terminal 112 may communicate with another movable platform, or a carrier or payload of another movable platform. When desired, the remote device may be a second terminal or other computing device (e.g., computer, laptop, tablet, smartphone, or other mobile device). The remote device can be configured to transmit data to the movable platform 118, receive data from the movable platform 118, transmit data to the terminal 112, and/or receive data from the terminal 112. Optionally, the remote device can be connected to the Internet or other telecommunications network, such that data received from the movable platform 118 and/or terminal 112 can be uploaded to a website or server.

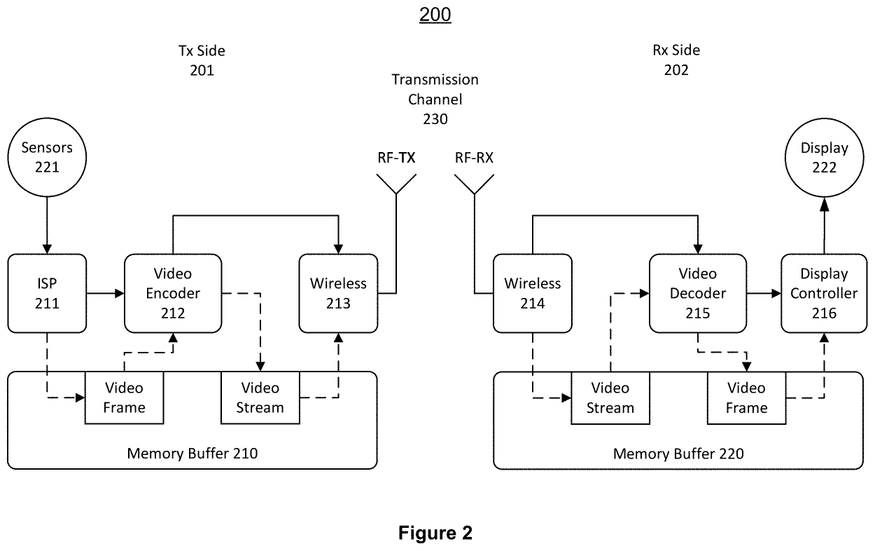

FIG. 2 shows an exemplary video processing/transmission system, in accordance with various embodiments of the present disclosure. As shown in FIG. 2, a video processing/transmission system 200 can employ a plurality of data processors 211-216 for performing various video processing and/or transmission tasks.

In accordance with various embodiments, the video processing/transmission system 200 may comprise multiple portions or subsystems, such as a transmission (Tx) side 201 and a receiving (Rx) side 202 connected via one or more wireless transmission channels 230.

As shown in FIG. 2, the data processors 211-213 on the Tx side 201 can take advantage of a memory buffer 210, and the data processors 214-216 on the Rx side 202 can take advantage of another memory buffer 220, for exchanging data and performing various data processing tasks. Alternatively, the different portions or subsystems of the video processing/transmission system 200 can share one common memory buffer or any number of memory buffers that are suitable for exchanging data and performing various data processing tasks.

The Tx side 201 of the video processing/transmission system 200 can include an image signal processor (ISP) 211 and, optionally, a data input processor (not shown). The data input processor can receive image frames from one or more sensors 221, e.g. via an input interface such as a mobile industry processor interface (MIPI). The image signal processor (ISP) 211 can process the received image frames using various image signal processing techniques.

Furthermore, the image processing system 200 can include a video encoder 212, which can encode the image information such as video frames obtained from an upstream data processor (e.g. the ISP 211). The video encoder 212 can be configured to encode the video frames to produce encoded video stream. For instance, the encoder 212 may be configured to receive video frames as input data, and encode the input video data to produce one or more compressed bit streams as output data. Moreover, the Tx side 201 of the video processing/transmission system 200 can include a wireless transmission processor 213 (e.g. a modem), which can transmit the encoded video stream to a remote terminal, e.g. for displaying.

On the other hand, the Rx side 202 of the video processing/transmission system 200 can include a wireless receiving processor 214 (e.g. a modem), which can receive the encoded video stream from the Tx side 201. Furthermore, the Rx side 202 of the video processing/transmission system 200 can include a video decoder 215, which can decode the received video stream. The decoder 215 may be configured to perform various decoding steps that are the inverse of the encoding steps by the encoder 212 in order to generate the reconstructed video frame data. Moreover, the video processing/transmission system 200 can transmit the decoded image frames to a display controller 216 for displaying the decoded image at a display 222. For example, the display 222 can be a liquid-crystal display (LCD), and the display controller 216 can be a LCD controller.

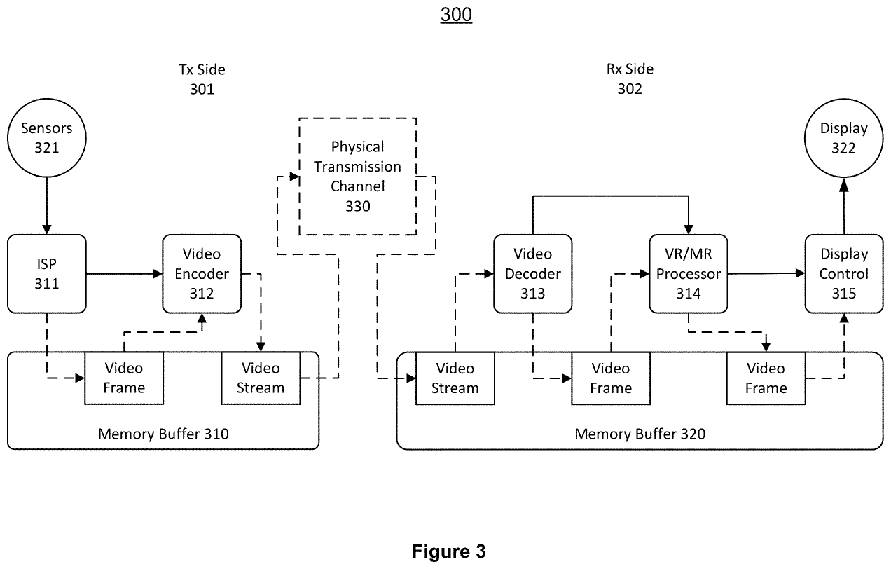

FIG. 3 illustrates an exemplary video streaming system, in accordance with various embodiments of the present disclosure. As shown in FIG. 3, the video streaming system 300 can employ a plurality of data processors 311-315 for performing various video processing and/or streaming tasks.

In accordance with various embodiments, a video streaming system 300 may include a transmission (Tx) side 301 and a receiving (Rx) side 302, connected via a physical transmission layer 330.

As shown in FIG. 3, the data processors 311-312 on the Tx side 301 can take advantage of a memory buffer 310, and the data processors 313-315 on the Rx side 302 can take advantage of another memory buffer 320, for exchanging data and performing various data processing tasks. Alternatively, the different portions or subsystems of the video streaming system 300 can share one common memory buffer or any number of memory buffers that are suitable for exchanging data and performing data processing tasks.

As shown in FIG. 3, the Tx side 301 of the video streaming system 300 can include an image signal processor (ISP) 311 and, optionally, a data input processor (not shown). The data input processor can receive image frames from one or more sensors 321, e.g. via an input interface such as a mobile industry processor interface (MIPI). The image signal processor (ISP) 311 can process the received video frames using various image signal processing techniques. Also, the video streaming system 300 can include a video encoder 312, which can encode the received video frames into one or more video streams.

Moreover, the Tx side 301 of the video streaming system 300 can stream the video stream to the receiving (Rx) side 302, via the physical transmission layer 330. The Rx side 302 of the video streaming system 300 can receive the encoded video stream. Furthermore, the video streaming system 300 may include a video decoder 313, which can decode the received encoded video stream into reconstructed video frames. Moreover, the video streaming system 300 can transmit the decoded image to a display control 315 for displaying, e.g. at a display 322.

Optionally, a virtual reality (VR)/augmented reality (AR) processor 314 can be used for preparing various scenes for displaying. For example, using virtual reality (VR), a user can experience a computer-generated virtual environment, e.g. via a headset covers the eyes. The augmented reality (AR), or mixed reality (MR), allows the overlay of real-time computer-generated data on a direct or indirect view of the real world. Using AR, the system enables a user's view of the real world to be augmented with computer-generated imagery that is beneficial to visualizing data intuitively.

In various traditional video processing systems, the data exchange between different modules are performed on a frame-by-frame basis. As a result, the user experience for video streaming applications based on the traditional video processing systems is unsatisfactory, due to the end-to-end communication delay in the traditional video processing systems. In accordance with various embodiments, a video processing system can reduce the end-to-end delay based on the collaboration, such as interaction and synchronization, between the software module(s) and hardware module(s). For example, the video streaming system 300 can take advantage of various hardware-software and hardware-hardware interaction interfaces, for supporting the various collaboration and cache management mechanisms, in order to minimize the end-to-end communication delay and achieve low overall latency.

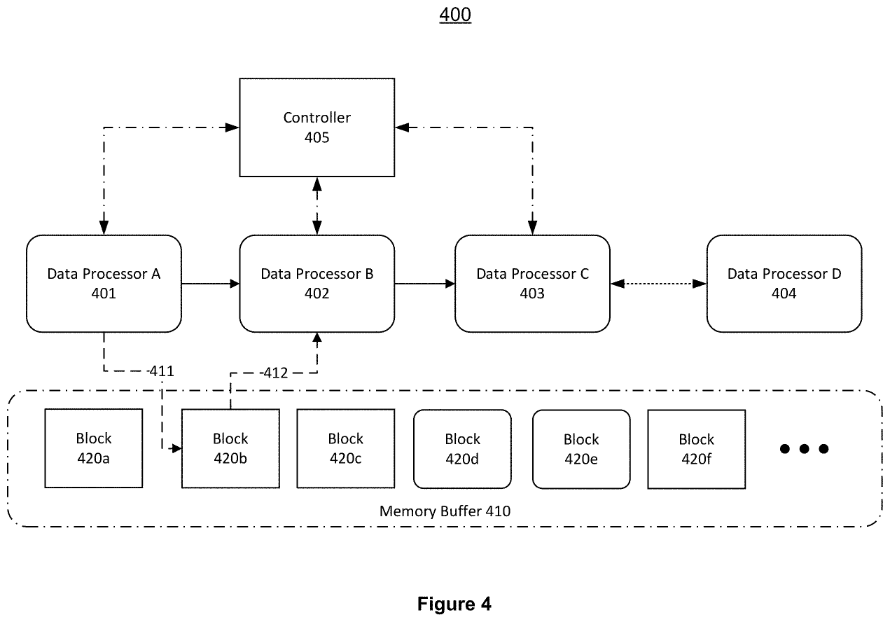

FIG. 4 illustrates an exemplary data processing system with low latency, in accordance with various embodiments of the present disclosure. As shown in FIG. 4, the data processing system 400 can employ a plurality of data processors, such as data processors A-D 401-404, for receiving and processing data received from one or more sensors (not shown). For example, the data processors A-D 401-404 can process the received data such as image frames using available procedures or algorithms (e.g. various image processing procedures or algorithms). Additionally, some of the plurality of data processors, e.g. the data processor D 404, may be a data transmission processor, which can be responsible for transmitting the processed data to a terminal that is physically or electronically connected to the data processing system 400 or a terminal that is remote from the data processing system 400.

In accordance with various embodiments, each of the data processors 401-404 can be a standalone processor chip, a portion of a processor chip such as a system on chip (SOC), a system in package (SiP) or a core in a processor chip. Also, the data processing system 400 can comprise a single integrated system or multiple subsystems that are connected physically and/or electronically (as shown in FIG. 2 and FIG. 3). For example, the data processing system 400 can be deployed on a movable platform. Different portions of the data processing system 400 may be deployed onboard or off-board a UAV. The data processing system 400 can efficiently process the images and/or videos that are captured by a camera carried by the UAV.

In accordance with various embodiments, the plurality of data processors, e.g. data processors A-D 401-404, may rely on a memory buffer 410 for performing various data processing tasks. The memory buffer 410 can comprise a plurality of buffer blocks, e.g. blocks 420a-f, each of which may be associated with a base address in the memory. Alternatively, the different portions or subsystems of the data processing system 400 can share one common memory buffer or any number of memory buffers that are suitable for exchanging data and performing data processing tasks.

As shown in FIG. 4, a controller 405 can be used for coordinating the operation of various data processors 401-404. For example, the controller 405 can activate and configure a data processor, e.g. the data processor B 402, which may be an off-line module, to perform one or more tasks. In one example, the controller 405 can provide the frame level information, such as buffer related information (e.g. a buffer identifier associated with the buffer block 420b), to the data processor B 402. Thus, the data processor B 402 can access the buffer block 420b using a base address associated with the buffer identifier. Furthermore, the data processor B 402 may proceed to write data in a different buffer block in the memory buffer 410. For example, this buffer block can be a buffer block in the memory buffer 410, which may be determined based on evaluating the base address of the buffer block 420b. Alternatively, this buffer block can be a pre-assigned or dynamically determined buffer block in the memory buffer.

In accordance with various embodiments, the data processing system 400 can take advantage of one or more memory buffers, which may be implemented using double data rate synchronous dynamic random-access memory (DDR SDRAM). For example, the memory buffer can be implemented using a ring buffer with multiple buffer blocks. Each buffer block can be assigned with a buffer identifier (ID), which can uniquely identify a buffer block in the memory buffer. Also, each buffer block can be associated with a base address, which may be used by a data processor to access data stored in the buffer block.

Additionally, each buffer block can be configured (and used) for storing data in unit, in order to achieve efficiency in data processing. For example, each buffer block may contain one image frame, which may be divided into one or more data units, e.g. slices or tiles. Alternatively, each buffer block may contain multiple image frames and each data unit may be a single image frame.

Furthermore, in order to reduce latency in data processing, the data processing system 400 allows multiple data processors to access a buffer block simultaneously. For example, the data processor A 401 can write data into the buffer block 420b, while the data processor B 402 is reading data out from the same buffer block 420b. As shown in FIG. 4, the data processor B 402 can receive fine granular control information directly from the data processor A 401. For example, such fine granular control information may indicate the status (or progress) of a write operation performed by the data processor A 401. In one example, the data processor A 401 can communicate with the data processor B 402 periodically, via a direct wire connection, for achieving efficiency and reliability. Thus, the data processing system 400 can avoid sending messages to an intermediate entity, such as the controller 405, in order to reduce the delay in data exchange between different modules in the system and alleviate the burden on the controller for handling messaging. Thus, the data processing system 400 can achieve low latency and also can reduce the burden on the controller 405 for handling a large amount of messages.

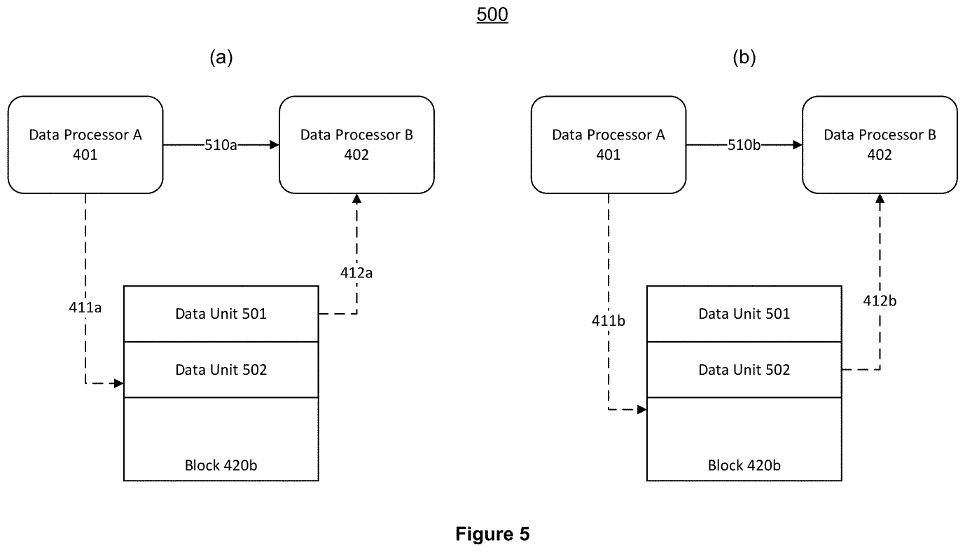

FIG. 5 shows supporting efficient data processing in a data processing system 500, in accordance with various embodiments of the present disclosure. As illustrated in FIG. 5(a), the data processor A 401 can perform a write operation 411a on a buffer block 420b. For example, the buffer block 420b can be used for receiving and storing multiple data units, e.g. the data units 501-502. Furthermore, the data processor A 401 can provide a reference 510a to the data processor B 402, which indicates a status (or progress) of the write operation performed by the data processor A 401.

In accordance with various embodiments, the data processor B 402 can use a predetermined threshold to determine whether the buffer block 420b contains enough data to be processed by the data processor B 402. For example, the predetermined threshold can indicate whether a data unit to be processed is available at the buffer block 420b. Alternatively, the predetermined threshold may define a data unit to be processed by a data processor. In various embodiments, a data unit can define a unit of data, such as a slice or a tile in an image frame, which may be processed together or sequentially to achieve efficiency. In accordance with various embodiments, the predetermined threshold can be evaluated based on the received reference information 510a or 510b. For example, the received reference information 510a or 510b may include information that indicates the percentage of a buffer block, total bytes or lines that have been completed by the write operation etc.

In the example as shown in FIG. 5(a), the data processor A 401 can perform a write operation 411a for writing data of the data unit 502 into the buffer block 420b. The data processor A 401 can provide fine granular control information 510a, such as a current line count, to the data processor B 402. For example, the line count may be larger than the line number associated with the data unit 501, but smaller than the line number associated with data unit 502. Thus, Data processor B 402 may proceed to obtain (e.g. via performing a read operation 411b) the data unit 501 from the buffer block 420b and wait for the data processor A 401 to finish writing the data unit 502, e.g. the Data processor B 402 may wait until enough data is available for the data unit 502 to be processed as a whole unit.

As shown in FIG. 5(b), the data processor A 401 can perform a write operation 411b for writing data into the buffer block 420b. The data processor A 401 can provide fine granular control information 510b, which may include a current line count, to the data processor B 402. This line count may be larger than the line number for data unit 502, which indicates that a write operation 411b performed by the data processor A 401 has finished writing data in the data unit 502. Thus, the Data processor B 402 can obtain (e.g. via performing a read operation 412b) the data unit 502 out from the buffer block 420b, since enough data is available in the data unit 502 for being processed as a whole. As a result, the data processing system 500 can achieve both low latency and reduce the burden on the controller 305 for handling messages.

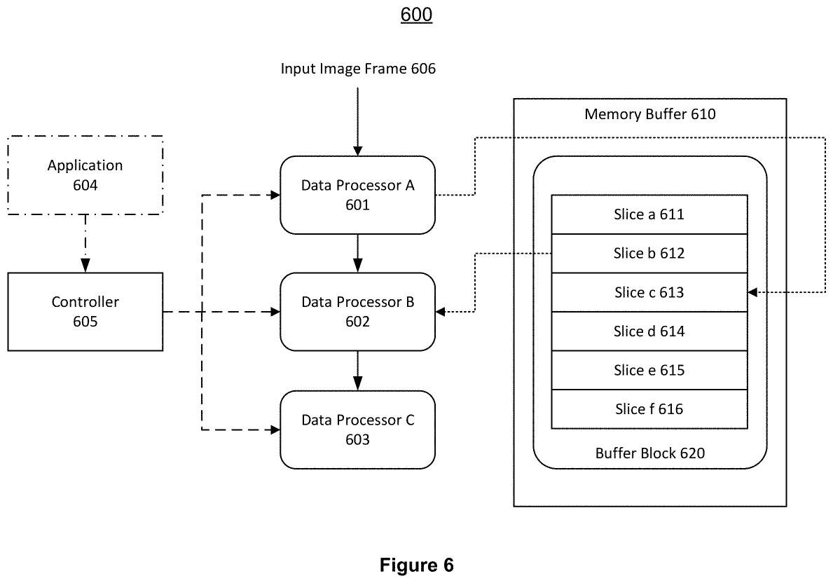

FIG. 6 shows an exemplary video processing system with low latency, in accordance with various embodiments of the present disclosure. As shown in FIG. 6, a video processing system 600 can employ a plurality of data processors 601-603 for processing an input image frame 606. For example, the data processor A 601 can write the image frame 606 into a buffer block 620 in the memory buffer 610 e.g. for performing various imaging processing tasks.

In accordance with various embodiments, an image frame can be partitioned into multiple data units. For example, using the H.264 standard, an image frame can comprise multiple slices or tiles, each of which may comprise a plurality of macroblocks. In another example, using the high efficiency video coding (HEVC) standard, an image frame can comprise multiple coding tree units (CTUs), each of which may comprises a plurality of coding units (CUs). In the example as shown in FIG. 6, the image frame 606 may be partitioned into a plurality of slices a-f 611-616. In another example, the image frame 606 may be partitioned into a plurality of lines or macroblocks.

In accordance with various embodiments, various software modules, e.g. a controller 605 running on a CPU, can activate and configure the different hardware modules, such as the data processors A-C 601-603, for processing the input image frame 606. For example, the controller can provide each of the data processors A-C 601-603 with a buffer identifier associated with the buffer block 620, so that the data processors A-C 601-603 can have access to the buffer block 620. For example, the data processor A 601 can use the buffer block 620 as an output buffer. Thus, the data processor A 601 can write the received (and optionally processed) image data into the buffer block 620. On the other hand, the data processor B 602 can use the buffer block 620 as an input buffer. Thus, the data processor B 602 may read and process the image data stored in the buffer block 620.

As shown in FIG. 6, the data processor A 601 and the data processor B 602 may access the buffer block 620 simultaneously. Also, the data processor A 601 can inform the data processor B 602 that it has finished the writing of slice b 612 in the buffer block 620. Correspondently, data processor B 602, the downstream processor, may start to read data in the slice b 612 from the buffer block 620 immediately in order to reduce the communication delay. Additionally, an application 604 can take advantage of the controller 605 for achieving various functionalities via directing the data processors A-C 601-603 to perform various image processing tasks.

Thus, the video processing system 600 can processes video or image data efficiently and can provide optimal user experience, since the software modules and hardware modules in the video processing system 600 can collaborate to achieve low latency. As shown in FIG. 2, the various data processors 211-213 and 214-216 can synchronize the processing status and/or state information directly via hardwired connections. For example, the ISP 211 can provide a line count or a slice count (in addition to the frame level information such as the buffer identifiers) to the video encoder 212 periodically. As soon as the ISP 211 finishes writing a predetermined portion of a video frame or a data unit (e.g. a slice or a tile) of a video frame in the memory buffer 210, the video encoder 212 may start to read out the related image data and encode the image data without a need to wait until the ISP 211 completes the processing of the whole image frame. Thus, the communication delay between the ISP 211 and the video encoder 212 can be reduced. Also, the wireless module 213 may be able to transmit a portion of the image frame as soon as the video encoder finishes processing the portion of the image frame. In a similar fashion, at the Rx side 202, the data processors 214-216 can reduce overall communication delay by sharing or exchanging processing status and/or state information directly via hardwired connections. As a result, the overall communication delay of the video processing system 200 can be drastically reduced. Similarly, as shown in FIG. 3, the various data processors 311-315 can share processing status and/or state information directly. Thus, the overall communication delay in the video streaming system 300 can be drastically reduced so that the video streaming system 300 can achieve optimal user experience.

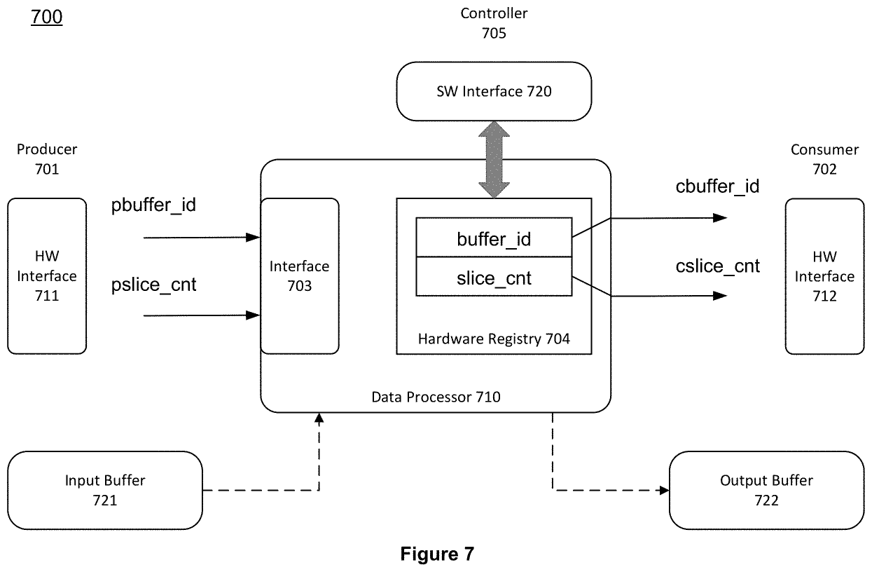

FIG. 7 illustrates an exemplary data processor in the data processing system, in accordance with various embodiments of the present disclosure. As shown in FIG. 7, a hardware module, such as a data processor 710, can interact with a software module, e.g. a controller 705 running on a CPU (not shown), via an interface 720. Additionally, the data processor 710 can interact with other hardware modules, e.g. a producer 701 and a consumer 702 (or other data processors). For example, the data processor 710 can interact with an upstream data processor, e.g. the producer 701, via a hardware interface 711 and the data processor 710 can interact with a downstream data processor, e.g. the consumer 712, via a hardware interface 712. Alternatively, the data processor 710 may interact with multiple upstream data processors and downstream data processors, via various hardware interfaces.

In accordance with various embodiments, the data processing system 700 allows the data processor 710 to interact with various software modules, e.g. via one or more physical or electronic connections between the data processor 710 and the underlying processor(s) that may be executing the software.

As shown in FIG. 7, the controller 705 can use the interface 720 for querying state information, such as buffer_id and/or slice_cnt in a hardware registry 704, from the data processor 710. For example, such state information can be provided to the controller 705 via periodic interrupts or being polled by the controller 705 periodically. In accordance with various embodiments, the data processor 710 can ensure that the buffer_id remains unchanged and slice_cnt may only increase monotonically during the processing of a particular data frame. Additionally, the controller 705 can use the interface 720 to configure an upstream module, e.g. the producer 701, and a downstream module, e.g. the consumer 702, for the data processor 710, so that the data processor 701 can efficiently perform various data processing tasks. For example, the controller can use the interface 720 to provide the data processor 710 with an input buffer identifier (e.g. pbuffer_id) associated with an input buffer 721. Also, the controller can use the interface 720 to provide the data processor 710 with an output buffer identifier (e.g. cbuffer_id) associated with an output buffer 722.

In accordance with various embodiments, the data processor 710 can synchronize with the upstream producer 701 and the downstream consumer 702 and exchanging various types of state information, via the interaction between the hardware modules. Such state information may include both frame level information and data unit level information. For example, the frame level information can include a buffer identifier (ID) or a frame number, and the data unit level information can include a slice count or a line count. As shown in FIG. 7, the data processor 710 can obtain the state information, e.g. pbuffer_id and pslice_cnt, from the producer 701 via the interface 711 (and the interface 703). Also, the processor 710 can provide the state information, cbuffer_id and cslice_cnt, to the consumer 702 via a hardware interface 712.

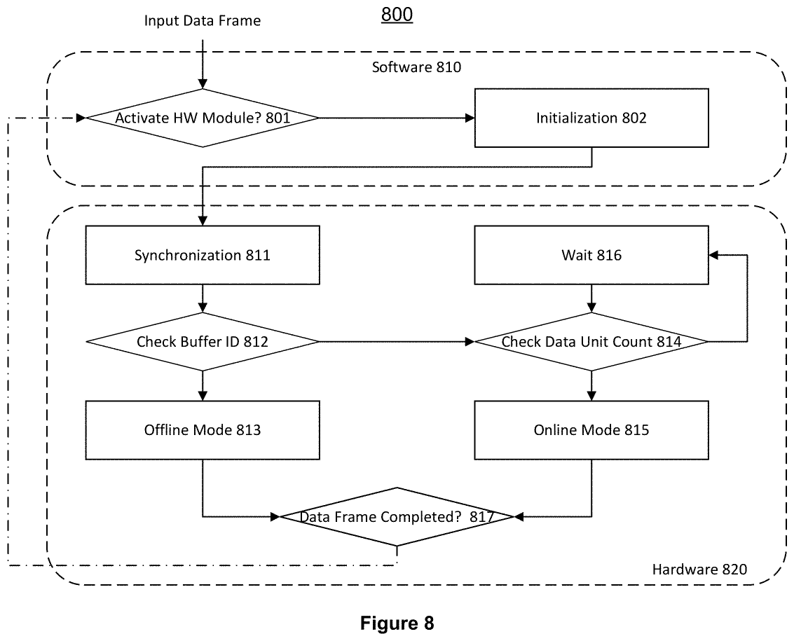

FIG. 8 shows hardware and software collaboration in an exemplary data processing system 800, in accordance with various embodiments of the present disclosure. As shown in FIG. 8, at step 801, a software module 810, e.g. a controller running on a CPU, can determine whether or not to activate a hardware module 820, e.g. a data processor, at a frame boundary (or level). For example, when the system receives an input data frame, the controller can check for the state of an input buffer associated with the data processor. If the input buffer is not empty or an upstream module is writing a data frame into the input buffer, the controller can activate and initialize the data processor. Thus, the controller can activate the data processor at the frame boundary for optimal scheduling.

At step 802, the system can perform various initialization steps. In various embodiments, the software module 810 can provide frame level information to the hardware module 820 and initialize the state information or status indicators, such as a data unit count (e.g. a slice count). For example, when activating a data processor, the controller can provide a buffer identifier (e.g. buffer_id) to the data processor and may set the output slice count (e.g. slice_cnt) to zero (0). Then, as the data processor processes a data frame from the buffer block, the buffer identifier may remain unchanged while the slice_cnt is expected to increase monotonically.

In accordance with various embodiments, the software module 810 can activate a plurality of hardware processors to perform various data processing tasks in a sequential fashion. In the example as shown in FIG. 4, the controller 405 can activate data processors A-D 401-404 for processing one or more image frames received from one or more sensors and transmitting the encoded video stream to a remote terminal for displaying.

At step 811, each hardware module 820 activated can perform a synchronization step. In various embodiments, the frequency of exchanging the state information offline can be minimized and the interaction between the software module 810 and hardware modules 820 can be optimized, in order to improve the efficiency of data processing. For example, the hardware module 820 can directly interact with the upstream and downstream modules through hardwired connection to synchronize (or exchange) state information with both the upstream module and downstream module. In the example as shown in FIG. 7, the data processor 710 can obtain pbuffer_id and pslice_cnt from a producer 701 via a hardware (HW) interface 711. Also, the data processor 710 can provide cbuffer_id and pcslice_cnt to a consumer 702 via a hardware (HW) interface 712. Additionally, for modules that the data processor 710 may not be able to directly synchronize or interact through hardwired connection, the data processor 710 may rely on the software module 810 to perform the status exchange and synchronization via periodical interrupts or polls. For example, as shown in FIG. 4, the data processor D 404, may obtain necessary information indirectly, via the controller 405.

Furthermore, the hardware module 820 can determine an operation mode based on the synchronization of state information, such as operation status of the upstream module. In accordance with various embodiments, the hardware module 820 can be directed to execute in either an online mode or an off-line mode. When executing in the offline mode, the hardware module 820 may proceed to complete the processing of a data frame in the buffer without unnecessary delay or interruption. On the other hand, when executing in the online mode, the hardware module 820 can be aware of the progress of an upstream hardware module.

In accordance with various embodiments, a downstream module (i.e. a consumer) may be activated immediately after the upstream module (i.e. a producer) is started. I.e., the processing of the same data frame may be performed automatically to minimize end-to-end delay. Thus, the system can ensure consistency of software scheduling via the internal hardware synchronization. For example, at step 812, the system can check whether the activated module and the upstream module are processing the same data frame. In the example as shown in FIG. 7, when the data processor 710 is activated, the system can check whether the pbuffer_id is the same as the cbuffer_id. If the pbuffer_id is different from the cbuffer_id, i.e. when the activated module and the upstream module are processing different data frames, the system can determine that the activated module is lagging behind the upstream module in processing data. In such a case, at step 813, the activated hardware module 820 can be set to execute in an offline mode, in which case the hardware module 820 may proceed to complete the processing of a data frame in the buffer without unnecessary delay or interruption.

On the other hand, if the pbuffer_id is the same as the cbuffer_id, i.e. when the activated hardware module 820 and the upstream module are processing the same data frame, the module can be configured to execute in an online mode. Running in the online mode, the hardware module 820 can be aware that a data unit is available for processing when it is ready. For example, at step 814, the hardware module 820 can check a count of data units that have already been processed by the upstream module, e.g. a slice count received from the upstream module via a hardwire connection. At step 815, the hardware module can execute in the online mode to keep pace with the upstream hardware module. In the example as shown in FIG. 7, when executing in the online mode, the data processor 710 can be automatically started to process a new slice, once the pslice_cnt received from the producer 701 changes. Also, the data processor 710 can update the output state (e.g. cslice_cnt) if necessary. In the meantime, the data processor 710 can be set to wait until a new slice is available for processing, at step 816. At step 817, when the data frame is completed, the hardware module 820 may remain offline until the software module 810 determines that a new data frame is ready to be processed.

Thus, the system can achieve low (or ultra-low) latency by allowing the hardware modules to interact and synchronize with each other at the data unit level (such as slice or line level) within a data frame, which allows the downstream processors to process the data frame with minimum delay.

In accordance with various embodiments, the system can use a memory buffer for exchanging data between the upstream and downstream modules. For example, the memory buffer can be implemented using a ring buffer (or a circular buffer) with multiple buffer blocks.

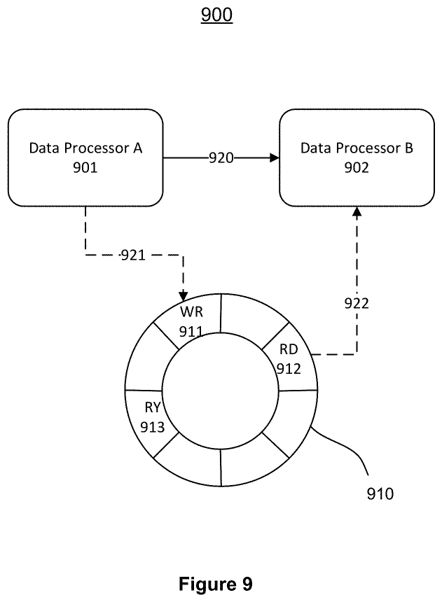

FIG. 9 illustrates data processing based on a ring buffer in a data processing system 900, in accordance with various embodiments of the present disclosure. As shown in FIG. 9, an upstream hardware module, e.g. a data processor A 901, and a downstream module, e.g. a data processor 902, can take advantage of a ring buffer 910 for exchanging data. In accordance with various embodiments, the ring buffer 901, which may comprise a plurality of buffer blocks that are connected end-to-end, is advantageous to buffering data streams, e.g. data frames, due to its circular topological data structure.

In accordance with various embodiments, a ring buffer management mechanism can be used for maintaining the ring buffer 910. For example, the data processor A 901 can write 921 a data frame into a buffer block 911, which may be referred to as a write frame (WR). Also, the data processor B 9012 can read 922 a data frame out from a buffer block 912, which may be referred to as a read frame (RD). Additionally, the ring buffer 910 may comprise one or more ready frames (RYs) stored in one or more buffer blocks. A ready frame 913 is written by an upstream module, e.g. the data processor A 901, in a buffer block and has not yet been processed by the downstream module, e.g. the data processor B 902. There can be multiple ready frames in the ring buffer 910, when the data processor B 902 is lagging behind the data processor A 901 in processing data in the ring buffer 910.

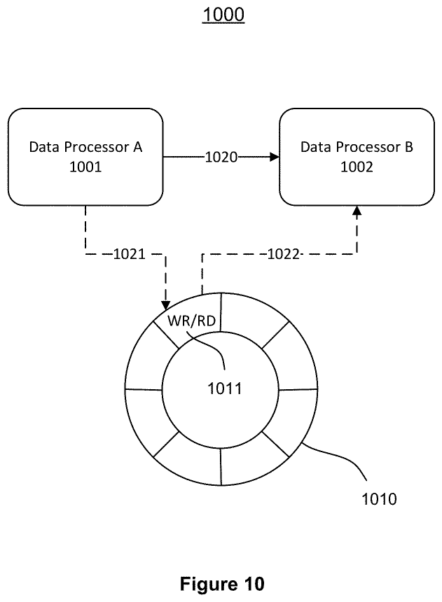

In accordance with various embodiments, the system may reach the optimal state with minimum delay when the downstream module can keep up with the progress of the upstream module. For example, FIG. 10 illustrates data processing with low latency based on a ring buffer in a data processing system 1000, in accordance with various embodiments of the present disclosure. As shown in FIG. 10, the buffer block 1011 in the ring buffer 1010 contains a data frame, which acts as both the write frame for the data processor A 1001 and the read frame for the data processor B 1002. Both the data processor A 1001 and the data processor B 1002 may be accessing on the same buffer block 1011 simultaneously. For example, the data processor A 901 may be writing 1021 data of a data frame in the buffer block 1011 while the data processor B 902 is reading 1022 data out from the buffer block 1011.

As shown in FIG. 10, the data processor A 1001 can provide the fine granular control information 1020 to the data processor B 1002, so that the data processor B 902 can keep up with the progress of the data processor A 1001. As a result, there may be no ready frame in the ring buffer 1010 (i.e. the number of ready frames in the ring buffer 1010 is zero).

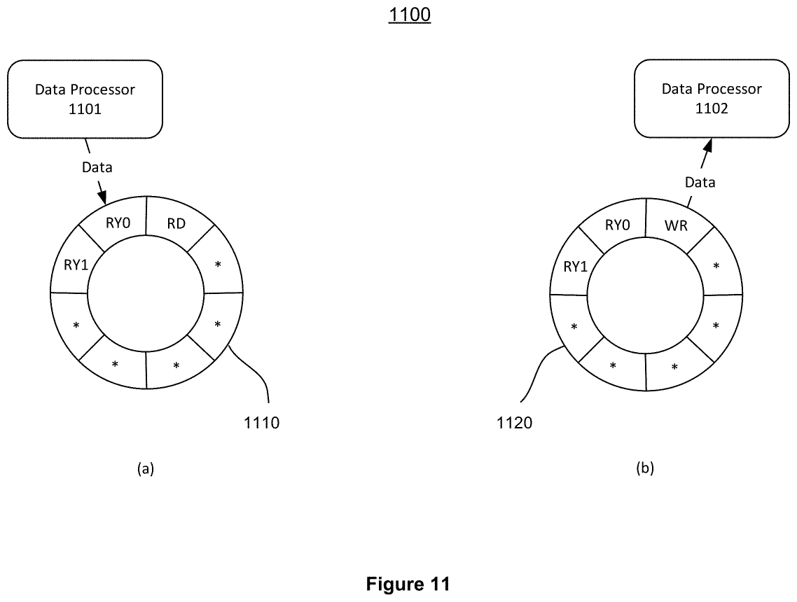

FIG. 11 illustrates activating a hardware module in an exemplary data processing system 1100, in accordance with various embodiments of the present disclosure. As shown in FIG. 11(a), when a controller in the data processing system activates a hardware module, e.g. the data processor 1101, as a producer, the system can check the output buffer, which may be a ring buffer 1110 associated with the data processor 1101. For example, the ring buffer 1110 may include a read frame (e.g. RD) and multiple ready frames (e.g. RY0 and RY1), when it is full. In order to achieve the optimal user experience, the system may skip a few frames when there is a delay in the system. For example, the controller can direct the data processor 1101 to use the latest ready frame, e.g. buffer block RY0, as the write frame.

As shown in FIG. 11(b), when a controller in the data processing system activates a hardware module, e.g. the data processor 1102, as a consumer, the system can check the status of an input buffer associated with the data processor 1102. For example, when the input buffer (e.g. a ring buffer 1120) is full, the controller can select the write frame as the new read frame if a write frame exists in the input buffer. On the other hand, if no write frame exists, the system can select the latest ready frame, e.g. buffer block RY0, as the new read frame. In other words, the system may skip a few frames when there is a delay in the system in order to achieve the optimal user experience.

Furthermore, a hardware module may be activated as both a producer and a consumer. Thus, the system can check the status for both the input buffer and output buffer, and follow the same frame buffer management strategy as described in the above respectively.

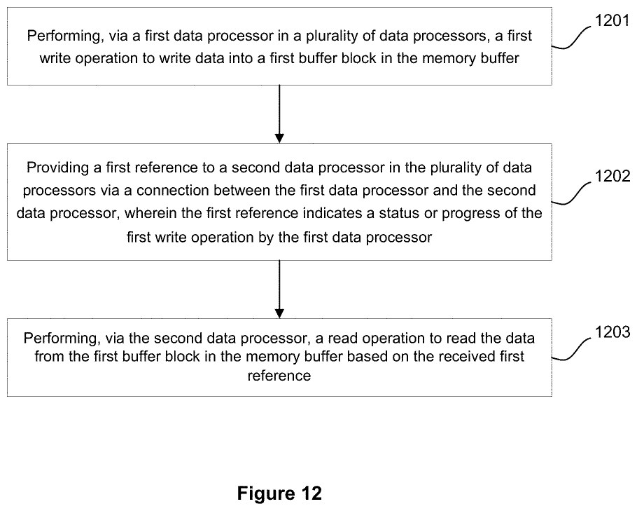

FIG. 12 shows a flowchart of supporting data processing and communication in a movable platform environment, in accordance with various embodiments of the present disclosure. As shown in FIG. 12, at step 1201, a first data processor can perform a first write operation to write data into a first buffer block in the memory buffer. Furthermore, at step 1202, the first data processor can provide a first reference to the second data processor via a connection between the first data processor and the second data processor, wherein the first reference indicates a status or progress of the first write operation by the first data processor. Then, at step 1203, the second data processor can perform a read operation to read the data from the first buffer block in the memory buffer based on the received first reference.

Many features of the present disclosure can be performed in, using, or with the assistance of hardware, software, firmware, or combinations thereof. Consequently, features of the present disclosure may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present disclosure can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Features of the disclosure may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A system for supporting data processing and communication in a movable platform environment, comprising:
a memory buffer with a plurality of buffer blocks, wherein each buffer block is configured to store one or more data frames; and
a plurality of data processors comprising at least a first data processor and a second data processor,
wherein the first data processor operates to
perform a write operation to write data into one of the buffer blocks in the memory buffer, and
provide a reference to the second data processor via a connection between the first data processor and the second data processor, wherein the reference indicates a status or progress of the write operation performed by the first data processor; and
wherein the second data processor operates to
perform a read operation to read the data from the one of the buffer blocks in the memory buffer based on the reference.

2. The system of claim 1, wherein:
the write operation is a first write operation, the one of the buffer blocks is a first buffer block in the memory buffer, the reference is a first reference; and
the second data processor operates to
perform a second write operation to write data into a second buffer block in the memory buffer; and
provide a second reference to a third data processor, wherein the second reference indicates a status or progress of the second write operation performed by the second data processor.

3. The system of claim 1, wherein each data frame comprises a plurality of data units, and wherein the reference comprises an input buffer identifier uniquely identifying the one of the buffer blocks, a data unit count that indicates a total number of data units written in the one of the buffer blocks, or a ratio that indicates a percentage of the one of the buffer blocks written by the write operation.

4. The system of claim 3, further comprising:
a controller that operates to activate the second data processor, wherein the controller operates to provide the second data processor with an output buffer identifier uniquely identifying a buffer block from which the second data processor is configured to read data.

5. The system of claim 4, wherein the second data processor operates to compare the input buffer identifier received from the first data processor with the output buffer identifier received from the controller.

6. The system of claim 5, wherein the second data processor is configured to operate in an online mode when the input buffer identifier received from the first data processor is the same as the output buffer identifier received from the controller.

7. The system of claim 5, wherein the second data processor is configured to operate in an offline mode when the input buffer identifier received from the first data processor is different from the output buffer identifier received from the controller.

8. The system of claim 4, wherein the controller operates to set a buffer identifier of a buffer block associated with a write frame or a most recent ready frame to be the output buffer identifier, when the second data processor is activated.

9. The system of claim 4, wherein the controller operates to set a buffer identifier of a buffer block associated with a read frame or a most recent ready frame to be the input buffer identifier, when the first data processor is activated by the controller.

10. The system of claim 1, wherein the memory buffer is configured to be a ring buffer with a circular topological data structure.

11. A method for supporting data processing and communication in a movable platform environment, comprising:
performing, via a first data processor, a write operation to write data into a buffer block in the memory buffer,
providing a reference to a second data processor via a connection between the first data processor and the second data processor, wherein the reference indicates a status or progress of the write operation performed by the first data processor; and
performing, via the second data processor, a read operation to read the data from the buffer block in the memory buffer based on the reference.

12. The method of claim 11,
wherein the write operation is a first write operation, the buffer block is a first buffer block in the memory buffer, the reference is a first reference;
the method further comprising:
performing, via the second data processor, a second write operation to write data into a second buffer block in the memory buffer; and
provide a second reference to a third data processor, wherein the second reference indicates a status or progress of the second write operation by the second data processor.

13. The method of claim 11, wherein each data frame comprises a plurality of data units, and wherein the reference comprises an input buffer identifier uniquely identifying the buffer block, a data unit count that indicates a total number of data units written in the buffer block, or a ratio that indicates a percentage of the buffer block written by the write operation.

14. The method of claim 13, further comprising:
activating, via a controller, the second data processor, wherein the controller operates to provide the second data processor with an output buffer identifier uniquely identifying a buffer block from which the second data processor is configured to read data.

15. The method of claim 14, further comprising:
comparing, via the second data processor, the input buffer identifier received from the first data processor with the output buffer identifier received from the controller.

16. The method of claim 15, wherein the second data processor is configured to operate in an online mode when the input buffer identifier received from the first data processor is the same as the output buffer identifier received from the controller.

17. The method of claim 15, wherein the second data processor is configured to operate in an offline online mode when the input buffer identifier received from the first data processor is different from the output buffer identifier received from the controller.

18. The method of claim 14, further comprising:
setting, via the controller, a buffer identifier of a buffer block associated with a write frame or a most recent ready frame to be the output buffer identifier, when the second data processor is activated.

19. The method of claim 14, further comprising:
setting, via the controller, a buffer identifier of a buffer block associated with a read frame or a most recent ready frame to be the input buffer identifier, when the first data processor is activated.

20. A non-transitory computer-readable medium with instructions stored thereon that, when executed by a processor, perform steps comprising:
performing, via a first data processor, a write operation to write data into a buffer block in a memory buffer,
providing a reference to a second data processor via a connection between the first data processor and the second data processor, wherein the reference indicates a status or progress of the write operation performed by the first data processor; and
performing, via the second data processor, a read operation to read the data from the buffer block in the memory buffer based on the received reference.
